(19) United States
(12) Patent Application Publication
(10) Pub. No.: US 2010/0300253 A1
(43) Pub. Date: Dec. 2, 2010

(54) Screw Holder for Screw Driving Tool

(76) Inventor: Donald W. Powell, Phoenix, AZ (US)

Correspondence Address: LOEN PATENT SERVICES, 2266 S Dobson Road, Ste 200, Mesa, AZ, 85202-6412, US

(21) Appl. No.: 12/784,980

(22) Filed: May 21, 2010

Related U.S. Application Data
(60) Provisional application No. 61/181,740, filed on May 28, 2009.

(51) Int. Cl. B25B 23/10

(52) U.S. Cl. 81/452

(57) ABSTRACT

The present invention is a screw holder that is useful for holding screws so that they may be started and conveniently screwed into the object or material without significant interruption of rotating motion. The present invention comprises a clear cylinder, along with end caps containing holes and radial slits. The screw is inserted in one end and the screw driving tool shaft is inserted in the other whereby the screw is conveniently held in place until it is properly started in the object or material.

### CROSS REFERENCE TO RELATED APPLICATIONS

This application claims the benefit of U.S. Provisional Application No. 61/181,740, filed on May 28, 2009. The provisional application is incorporated herein by reference.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

The present invention is generally directed toward hand tools, and in particular, tools used for the insertion of screws into wood, metal, drywall, stone, masonry, concrete, and the like. The present invention may be used as an adaptation to existing tooling, or as a separate, additional enhancement. The present invention is particularly related to the proper holding of screws conveniently for the use of screw insertion tools in a variety of positions, which include horizontal, vertical, and other angular positions.

(2) Description of Related Art

U.S. Pat. No. 6,776,069 describes a device for holding a screw onto an electric screwdriver. A cylinder is added to the end of the screwdriver which holds the screw. The screw holder has the distinct disadvantage of being specifically designed for a particular screwdriver. It is not a universal style of design which is adapted to a variety of tools. Also, the removal of the screw holder requires pulling off the holder in an awkward manner prior to the complete insertion of the screw into the part or material it is being inserted into. The additional steps discourage actual use of the screw holder due to the inconvenience.

U.S. Pat. No. 5,129,292 describes a cylindrical screw starter. Unfortunately, the design is lacking in important convenience features. The design is suitable only for a particular screw length, and consequently a user must maintain an inventory of a variety of cylinders to pick out one for a particular screw length. The cylinder quickly ‘bottoms out’ for a particular screw length, which means that the cylindrical screw starter may not have enough turning ability to reliably start the screw, depending on the amount of screw length needed to be inserted before a rigid connection is made. The tube is designed around slotted screws, not the more popular Phillips screws. A separate tube is also needed for each screw diameter. In summary, the design does not take a more universal screw approach.

U.S. Pat. No. 4,526,072 describes a cylindrical screw holder that is used as an aid in starting and holding screws. However, as a practical matter, there are important difficulties in actual use and production. The bristles inside the cylinder are difficult to manufacture and actually insert into the cylinder. The bristles tend to wear or fatigue easily, and then the screw is not held in line with the cylinder. The bristles at one end become pinched between the screw and part when the screw is inserted into the part. It is difficult to see the end of the screw and correctly insert the screw driver into the end of the screw.

### BRIEF SUMMARY OF THE INVENTION

The present invention is a screw holder that is useful for holding screws so that they may be started and conveniently screwed into the part or material without significant interruption of rotating motion. The present invention takes a universal approach, and utilizes a screw holder which is adapted for a variety of screw sizes and lengths.

### BRIEF DESCRIPTION OF THE SEVERAL VIEWS OF THE DRAWING(S)

FIGS. 1A-1E are an example of the use of the present invention.

FIGS. 2A-2B are a profile and isometric view of the present invention.

FIGS. 3A-3B are another embodiment of the present invention to allow an easy insertion of a screw.

### DETAILED DESCRIPTION OF THE INVENTION

The present invention is adapted to improve over the difficulties and obstacles of previous efforts of others, and additionally, provide for enhanced features to ensure usefulness in actual use.

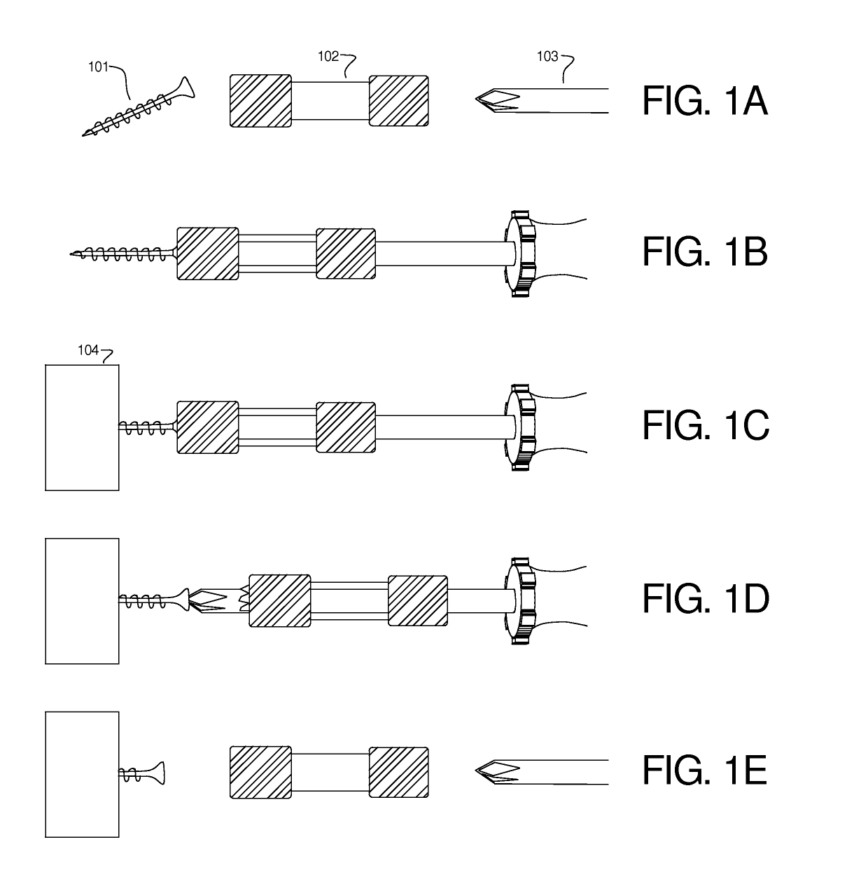

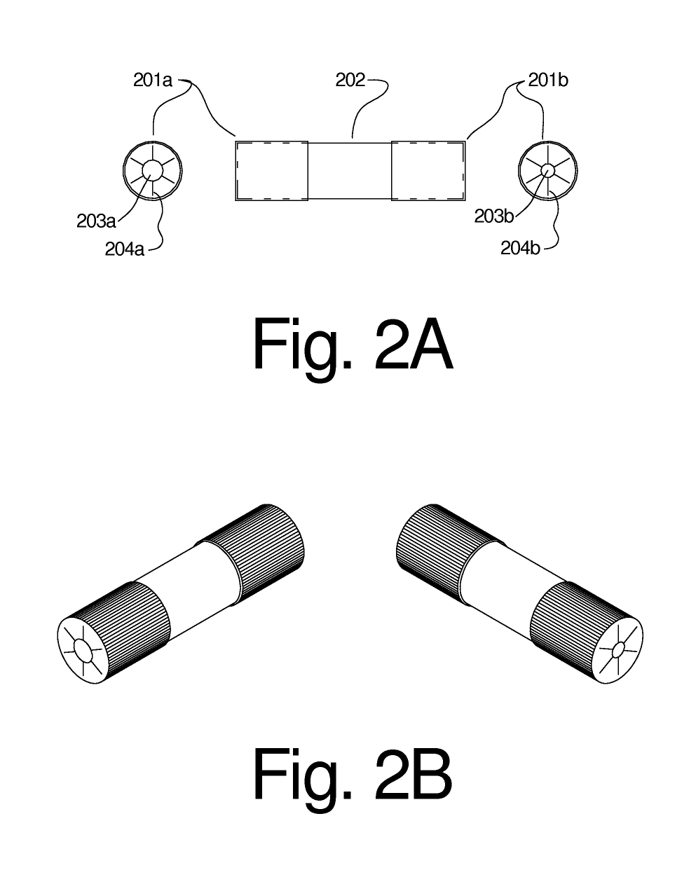

FIGS. 1A-1E are an example of the use of the present invention. In FIG. 1A, a screw 101, along with a screw holder 102, as described in FIGS. 2A and 2B, and a screw driver are shown. In FIG. 1B, the screw 101 is inserted into one end of the screw holder 102, and the screw driver 103 is inserted into the other end of the screw holder 102. Additionally, the screw driver is pushed into the end of the screw and the screw driver end is properly engaged into the screw in order to turn it. This is conveniently done by holding both the screw and screw driver with each hand, and then sliding them together and rotating them slightly until they are satisfactorily engaged and aligned. In FIG. 1C, the assembly of FIG. 1B is then used to drive the screw into a wooden beam 104 by rotating the screw driver. In general, the entire assembly of FIG. 1B rotates, however, it is not a requirement that the screw holder 102 rotate. In FIG. 1D, the screw holder 102 is slid back onto the screw driver 103 shaft in order to complete the insertion of the screw into the wooden beam. This prevents the screw holder from being caught underneath the screw when it is completely inserted. In FIG. 1E, the screw driver is withdrawn from the screw and the screw holder is pulled off of the screw driver shaft. The screw holder may then be re-used for another screw.

FIG. 2A-2B is a profile and isometric view of the present invention. In FIG. 2A, the end pieces or end caps 201a, 201b are rigidly mounted onto a connecting middle piece made out of a clear plastic cylinder 202 with ends that are open. The end caps feature drilled holes 203a, 203b, with radial slits 204a, 204b which allow easy insertion of a screw by providing flexibility. The end caps are preferably made of a flexible elastomer, a rubber compound, or a flexible plastic compound that is tough enough to withstand multiple uses without breakage or significant wear. Polypropylene is one material that has been found to be successful in application. The end caps are rigidly attached to the clear cylinder and may be glued on; heat sealed on, pressed on, or fitted by a tolerance fit by use of stretching the end cap.

The middle peace is a clear plastic cylinder 202 and is preferably a made from a clear plastic, so as to allow convenient visual spotting of the end of the screw and properly engaging the screw driving tool end into the end of the screw. The diameter of the plastic cylinder is large enough to allow the desired screw to pass through. A clear plastic cylinder is not a requirement and a solid cylinder, i.e. visually opaque, may also be employed with success. The cylinder preferably has dimensions which are substantially ½ inches in diameter and 2 inches long, and is made out of a strong plastic such as an acrylic. Useful diameter variances are ±⅛ of an inch and useful length variances are ±½ of an inch. In general, the middle piece does not have to be in the exact shape of a cylinder, an elongated hollow core piece that allows a screw to pass through is required.

The end cap holes are in the range of approximately ⅛ to 3/16 of an inch for convenient insertion of a variety of typical screws and other hardware. The holes are substantially centered on the lengthwise axis of the middle piece. This range of end cap holes will also be large enough for insertion of typical driving shaft diameters of the screw rotating tool. The screw rotating tool may be either manual or powered. Radial slits, at least one on each end, provide very convenient flexibility for a variety of screws with a single central hole. The center hole dimensions are approximate and may vary within the range of ⅛ to 3/16 of an inch to accommodate a variety of screw, bolt, and hardware configurations. In one embodiment, each end cap will have a different diameter so as to provide convenient flexibility for operator use.

In another embodiment of the invention, the screw holder is miniaturized to handle small screws, and the center hole dimension is very small. Such a holder would be useful, for example, in the electronics industry where screws are exceptionally small.

| | Screw Size Number | | | | | | | | | | |
|---|---|---|---|---|---|---|---|---|---|---|---|
| | 000 | 00 | 0 | 1 | 2 | 3 | 4 | 5 | 6 | 8 | 10 |
| Diameter (inches) | 0.034 | 0.047 | 0.060 | 0.073 | 0.086 | 0.099 | 0.112 | 0.125 | 0.138 | 0.164 | 0.190 |

In this case, the length of the screw holder would be reduced, and the screw driving tool would be a smaller diameter. Consequently the overall length would be small, sometimes very small, to hold the screw conveniently.

In general, the screw holder maximum length would be 2.5 inches and the maximum diameter would be ⅝ of an inch.

The screw holder is particularly useful when the screw is initially being inserted into an object or material. However, it is then withdrawn onto the tool shaft, as illustrated in FIG. 1D, prior to completion of inserting the screw to avoid being caught under the screw head. The screw holder is useful for holding the screws onto the screw driving tool in a variety of positions that include vertical, horizontal, and other angles in between.

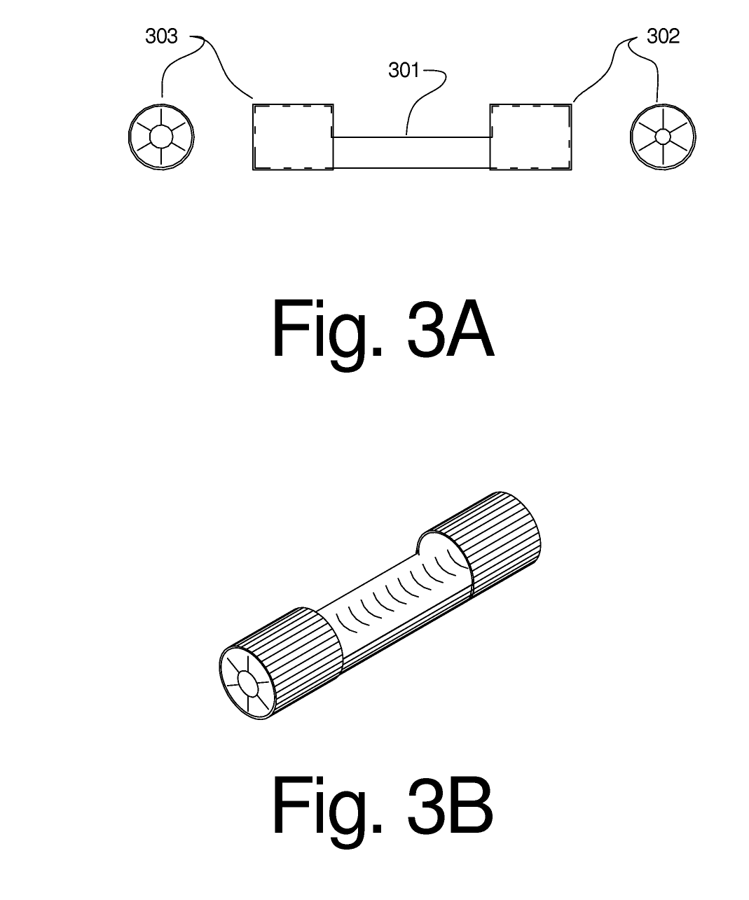

FIGS. 3A-3B shows another embodiment of the present invention. FIGS. 3A-3B show a profile and isometric view of the present invention where the clear plastic cylinder of FIG. 2A-2B is modified by removing a section of the cylinder to allow an easy insertion of a screw so that the screw is placed inside the screw holder by ‘pushing it through.’ This provides for additional convenience without sacrificing stiffness or integrity of the holder, provided that the middle piece 301 is sufficiently strong to bridge the gap between the screw holding end piece 302 and the screw driving tool end piece 303.

In an embodiment of the present invention the clear plastic cylinder is made out of an engineered thermoplastic. Typical engineered thermoplastics are: Acetal, Cellulosics, Nylon, polycarbonate, polyester, polyurethane, polyphenylene oxide PPO/polyphenylene-ether (PPE), Styrene Acrylonitrile (SAN), Styrene Maleic Anhydride (SMA), Thermoplastic Acrylic Resin (TPA), Thermoplastic elastomers (TPE), and ultra high molecular weight polyethylene (UHMW-PE). The cylinder is preferably made out of, but not limited to, one of these materials. It may be selected from another material provided it is suitable for use and is commercially acceptable.

While various embodiments of the present invention have been described, the invention may be modified and adapted to various operational methods and other types of driving tools to those skilled in the art. Therefore, this invention is not limited to the description and figure shown herein, and includes all such embodiments, changes, and modifications that are encompassed by the scope of the claims.

I claim:

1. A screw holder useful for holding a screw for a screw driving tool comprising:
a) a first end piece and a second end piece,
b) an elongated middle piece with two ends, wherein said elongated middle piece incorporates a hollow core large enough for a screw to pass through,
c) wherein said first end piece is placed over an end of said elongated middle piece and rigidly connected, and said second end piece is rigidly placed over the other end of said elongated middle piece and rigidly connected,
d) wherein said first end piece and said second end piece are made from a flexible material,
e) wherein said first end piece and said second end piece incorporate a hole up to 3/16 of an inch inclusive which is substantially centered along the lengthwise axis of said elongated middle piece,
f) wherein said screw holder is up to ⅝ inches in diameter inclusive,
g) wherein said screw holder is up to 2.5 inches long inclusive,
h) wherein said first end piece and said second end piece incorporate at least one radial direction slit to provide flexibility for insertion of screws or screw driving tool shafts,
whereby said screw holder is useful for holding said screw during an initial insertion into an object or a material.

2. The screw holder according to claim 1 wherein said elongated middle piece is visually clear.

3. The screw holder according to claim 1 wherein said first end piece and said second end piece are made from a flexible elastomer, a rubber compound, or a flexible plastic compound,

4. The screw holder according to claim 1 wherein said elongated middle piece incorporates an opening for insertion of said screw.

5. The screw holder according to claim 1 wherein
a. said screw holder is between ⅜ and ⅝ inches in diameter inclusive, and
b. wherein said screw holder is between 1.5 and 2.5 inches long inclusive.

6. The screw holder according to claim 1 wherein said elongated middle piece is substantially the shape of a hollow cylinder.

7. The screw holder according to claim 6 wherein said elongated middle piece incorporates an opening for insertion of said screw.

8. The screw holder according to claim 6 wherein said first end piece and said second end piece are both substantially in the shape of a hollow cylinder which additionally includes an end disc that incorporates said hole.

9. The screw holder according to claim 6 wherein said elongated middle piece is made out of an engineering thermoplastic.
